(19) United States
(12) Patent Application Publication
(10) Pub. No.: US 2022/0391153 A1
(43) Pub. Date: Dec. 8, 2022

(54) LOCATION IDENTIFICATION FOR IMAGING DEVICES

(71) Applicant: Hewlett-Packard Development Company, L.P., Spring, TX (US)

(72) Inventors: Shakti Amarendra, Bangalore (IN); Abhinav Yadav, Bangalore (IN); Debayani Sarangi, Bangalore (IN); Balaji Yalamarthi, Bangalore (IN); . Sharanabasappa, Bangalore (IN)

(21) Appl. No.: 17/769,971

(22) PCT Filed: Oct. 8, 2020
(86) PCT No.: PCT/US2020/054814

§ 371 Date: Apr. 18, 2022

(30) Foreign Application Priority Data
Dec. 9, 2019 (IN) 201941050865

(51) Int. Cl. G06F 3/12

(52) U.S. Cl. CPC G06F 3/1226; G06F 3/1288

(57) ABSTRACT

Techniques for identifying location of an imaging device within a networked environment are described. According to an example of the present subject matter, jobs received by the imaging device from client devices are analysed to ascertain a level of utilization of the imaging device by each of the client devices. A location of each of the client devices is also determined. From amongst the locations of the client devices, a location for the imaging device is identified based on the level of utilization of the imaging device by the respective client devices.

### BACKGROUND

Imaging devices, such as plotters, printers, scanners, and photocopiers render content on a compatible medium on receiving a job from a client device. For example, imaging devices, such as plotters, printers, and photocopiers print content on print media on receiving a print job. While a scanner may generate an electronic copy of a document on receiving a scan job. An imaging device may also be implemented as a multi-functional imaging device. For instance, a multi-functional printer may incorporate, along with its capability to print content, functionality of a scanner and/or functionality of a fax machine. In another example, a scanner may also create a physical copy of a document thereby exhibiting functionalities of a photocopying device.

Accordingly, imaging devices may be installed in workplaces and homes and be made accessible to users to enable the users to utilize the various functionalities of the imaging devices.

### BRIEF DESCRIPTION OF FIGURES

The following detailed description references the drawings, wherein:

FIG. 1 illustrates a networked environment housing an imaging device and a plurality of client devices coupled to the imaging device, in accordance with an example implementation of the present subject matter;

FIG. 2 illustrates the imaging device, in accordance with an example implementation of the present subject matter;

FIG. 3 illustrates the imaging device, in accordance with another example implementation of the present subject matter;

FIG. 4 illustrates a method for identifying a location for the imaging device within a networked environment, in accordance with another example implementation of the present subject matter;

FIG. 5 illustrates a method performed by the imaging device to determine respective locations of at least three of the client devices, according to an example of the present subject matter;

FIGS. 6a and 6b illustrate methods performed by the imaging device to determine a location of an additional client device other than the at least three client devices, according to an example of the present subject matter; and

FIG. 7 illustrates a method for identifying a location for the imaging device from amongst the respective locations of the client devices, according to an example implementation of the present subject matter.

FIG. 8 illustrates a computing environment implementing a non-transitory computer-readable medium for identifying a location for the imaging device within the networked environment, according to an example of the present subject matter.

### DETAILED DESCRIPTION

Imaging devices, such as plotters, printers, fax machines, scanner, and photocopiers may receive a job from a user and perform an operation to render contents received in the job on a compatible medium. The imaging devices may be located in a networked environment comprising the imaging device and multiple client devices that may connect to the imaging device to use functionalities of the imaging device. The networked environment may exist in a premises, such as a house, an office, or an portion, such as a few floors thereof, housing the imaging device and the client devices that connect to the imaging device.

The imaging device installed in the networked environment is to be physically accessed by the users in order to be utilized. For example, following completion of a print job, a user may access the imaging device to retrieve printed media. Similarly, the execution of a scan job by the imaging device may involve placing a document to be scanned on a scanning bed of the imaging device.

Generally, the utilization of the imaging device is based on the accessibility of the imaging device to various users of client devices that are connected to the imaging device to use functionalities of the imaging device. For instance, a client device located close to the imaging device in the networked environment is likely to generate more jobs as compared to another client device that may be located on another floor within the networked environment.

Also, given that an extent of utilization of the imaging device by the various users of the client devices within the networked environment may vary, increasing the ease of accessibility of the imaging device for a client device that has higher utilization of the imaging device as compared to the other client devices, may also enhance the overall utilization of the imaging device.

According to an example of the present subject matter, techniques to identify a location for an imaging device within a networked environment are described. Example techniques described herein enable the imaging device to be located within the networked environment at a location that would result in maximum utilization of the imaging devices by client devices in the networked environment.

According to an example of the present subject matter, example techniques for identifying locations for imaging devices in networked environments are described herein. According to the present subject matter, an imaging device receives corresponding distances of at least three client devices with respect to each other and with respect to the imaging device. Each of the at least three client devices is located within the networked environment. Based on the received distances, the imaging device identifies respective locations of each of the at least three client devices within the networked environment. Starting with determining the respective locations of at least three client devices, the imaging device identifies corresponding locations of additional client devices within the networked environment that may be communicating with the imaging device. Each of the respective locations of the client devices within the networked environment may be a potential location for the imaging device.

Having determined the respective locations of the client devices within the networked environment, the imaging device analyses jobs issued to it by each of the client devices to ascertain a level of utilization of the imaging device by each of the client devices. The jobs issued to the imaging device comprise print jobs or scan jobs. The imaging device identifies a location for itself within the networked environment, from amongst the respective locations of the client devices based on the analysis.

To ascertain a level of utilization of the imaging device by each of the client devices, the number of jobs issued by each of the client device along with the consumption of consumable supplies, such as print media and ink consumed in performing an operation in response to each job issued by the respective client device is taken into consideration. This provides for the identification of a client device that has a higher utilization of the imaging device as compared to the other client devices. Since the location of the imaging device is identified based on the level of utilization of each of the client devices within the networked environment, the ease of accessibility of the imaging device to the client devices that have higher utilization of the imaging device as compared to the other client devices is increased, owing to which the overall utilization of the imaging device is enhanced.

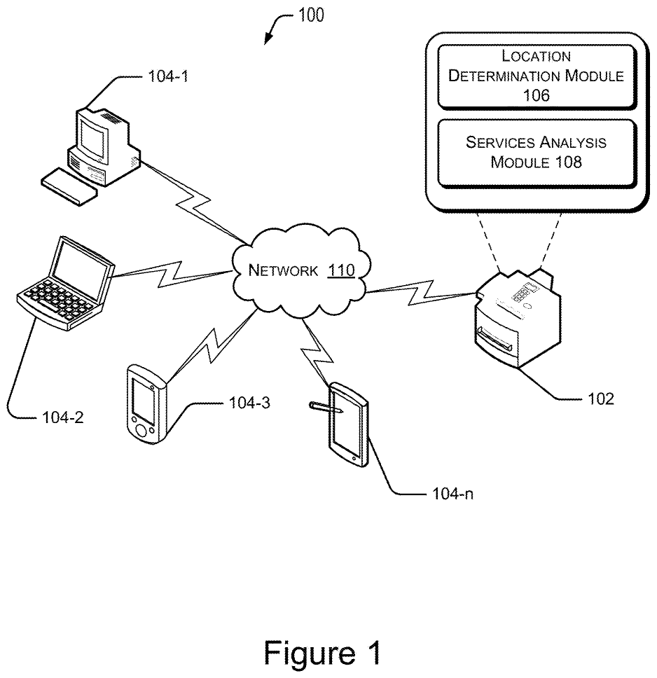

The above techniques are further described with reference to FIG. 1 to FIG. 8. It should be noted that the description and the figures merely illustrate the principles of the present subject matter along with examples described herein and should not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 shows a networked environment 100 comprising an imaging device 102 and a plurality of client devices 104-1, 104-2, . . . and 104-n coupled to the imaging device 102 according to an example of the present subject matter. For example, the networked environment 100 may be understood as an interconnection of the imaging device 102 and the plurality of client devices 104-1, 104-2, . . . and 104-n, wherein each of the plurality of client devices 104-1, 104-2, . . . and 104-n connect to the imaging device 102 via the same or different communication means. Examples of imaging device 102 include plotters, printers, scanners, digital senders, single function printer (SFP), multi-function printer (MFP), and photocopiers. In an example, a plurality of imaging devices may be present in the networked environment 100, however, for the simplicity, the imaging device 102 alone is shown in the FIG. 1. However. it will be understood that the techniques for identifying the location of the imaging device 102 within the networked environment 100 may be implemented in any of the plurality of imaging devices to identify their respective locations within the networked environment 100.

The imaging device 102 may be accessed by the plurality of client devices 104-1, 104-2, . . . and 104-n via a network 110 for using functionalities of the imaging device 102. Examples of the client devices 104-1, 104-2, . . . and 104-3 may include but are not limited to, electronic devices, such as, desktop computers, laptops, smartphones, personal digital assistants (PDAs), and tablets. The plurality of client devices 104-1, 104-2, . . . and 104-n may issue jobs to the imaging device 102 to utilize a functionality of the imaging device 102. The jobs may instruct the imaging device 102 to render contents on a compatible medium. Examples of the jobs may comprise print jobs, scan jobs, or jobs to create copies of a document by scanning the document as well as printing the scanned content on a media. In an example, a client device, such as, the client device 104-1 may issue a scan job to the imaging device 102 to render content of a print media in an electronic medium. In another example, the client device 104-2 may provide a job to the imaging device 102 to create an enlarged copy of a painting.

In an example, the imaging device 102 may receive the jobs from the plurality of client devices 104-1, 104-2, . . . and 104-n, over the network 110. In an example, the network 110 may be a single network or a combination of multiple networks and may use a variety of different communication protocols. The network 110 may be a wireless or a wired network, or a combination thereof. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NON), Public Switched Telephone Network (PSTN). Depending on the technology, the network 108 includes various network entities, such as, gateways, routers; however, such details have been omitted for sake of brevity of the present description.

In accordance with an example implementation of the present subject matter, the imaging device 102 comprises a location determination module 106.

The location determination module 106 identifies respective locations of the client devices 104-1, 104-2, . . . and 104-n located within the networked environment 100. The location determination module 106 may identify a location for the imaging device 102 within the networked environment 100, from amongst the locations of the client devices 104-1, 104-2, . . . and 104-n issuing jobs to the imaging device 102. To identify the locations of the client devices 104-1, 104-2, and 104-n, the respective distances of the client devices 104-1, 104-2, and 104-n with respect to the imaging device 102 along with the distances of the client devices 104-1, 104-2, and 104-n with respect to each other is taken into consideration. In other words, the location determination module 106 identifies the respective locations of each of the client devices 104-1, 104-2, . . . and 104-n in a 3-dimensional space formed by the client devices 104-1, 104-2, . . . and 104-n and the imaging device 102. From amongst the respective locations of the client devices 104-1, 104-2, . . . and 104-n within the networked environment as identified by the location determination module 106, a location for the imaging device 102 may be selected.

In accordance with an example implementation of the present subject matter, the location of the imaging device 102 is identified, from amongst the respective locations of the client devices 104-1, 104-2, . . . and 104-n, on the basis of an analysis of the jobs issued to the imaging device 102 by each of the client devices 104-1, 104-2, . . . and 104-n. The analysis of the jobs issued to the imaging device 102 by each of the client devices 104-1, 104-2, . . . and 104-n, is carried out by a services analysis module 108 of the imaging device 102 to ascertain a level of utilization of the imaging device 102 by each of the client devices 104-1, 104-2, . . . and 104-n.

In an example, the location of the imaging device 102 is identified, such that the ease of accessibility of the imaging device 102 to a client device that has a highest utilization of the imaging device 102 amongst the client devices 104-1, 104-2, . . . and 104-n, is increased. For example, the location of a client device, such as, the client device 104-1 that may have higher utilization of the imaging device 102 as compared to the other client devices 104-1, 104-2, . . . and 104-n may be identified as the location of the imaging device 102. Accordingly, a notification may be generated for a user, such as, an administrator of the imaging device 102 to relocate the imaging device 102 to the location of the client device 104-1, such that the imaging device 102 is in the vicinity of the client device 104-1 and is readily accessible thereto.

Thus, the present subject matter enables the imaging device 102 to be located within the networked environment 100 at a location that would result in maximum utilization of the imaging device 102 by the client devices 104-1, 104-2, . . . and 104-n in the networked environment 100 by enhancing the ease of accessibility of the imaging device 102 to a client device that has higher utilization of the imaging device 102 as compared to the other client devices.

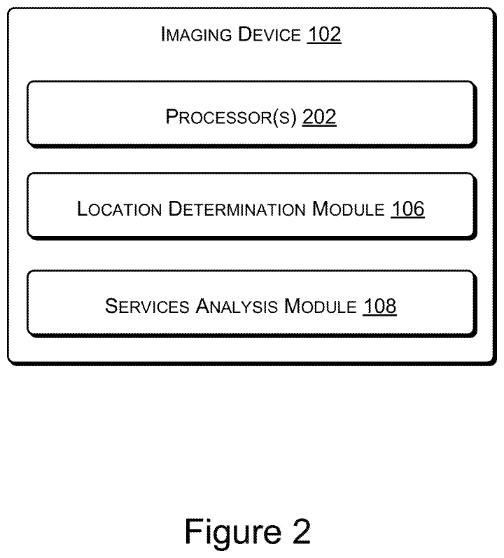

FIG. 2 shows the imaging device 102, according to another example implementation of the present subject matter. In the example implementation depicted in FIG. 2, the imaging device 102 may be a printer, for example, a single function printer (SFP) or a multi-function printer (MFP).

As explained previously, the imaging device 102 may receive jobs from the client devices 104-1, 104-2, . . . and 104-n communicatively coupled to the imaging device 102 for using functionalities of the imaging device 102. The job may, for example, be understood as a command comprising instructions provided to the imaging device 102 for rendering contents associated with the job on the compatible medium. A job may include but not be limited to a print job or scan job. For example, if the job received from a client device is a print job, the instructions may include instructions indicating whether a simplex printing or duplex printing is to be performed, a number of colors and print resolution to be used to execute the print job and the like.

In accordance with an example implementation of the present subject matter, the imaging device 102 comprises the location determination module 106 and the services analysis module 108, coupled to a processor 202 of the imaging device 102. In an example, the processor 202 may be implemented as microprocessors, microcomputers, microcontrollers, digital signal processors, central processing units, state machines, logic circuitries, and/or any devices that manipulate signals based on operational instructions.

The services analysis module 108 is operable to analyse the jobs, such as, a print job or a scan job received by the imaging device 102 to compute a number of pages of a print media to be consumed by the respective jobs and a quantity of printing ink to be consumed by the respective jobs. The printing ink may include but not limited to toner, pigments and various additives. The pigments may be of any color. In an example, the services analysis module 108 assigns a weight to each of the plurality of jobs based on the number of pages and quantity of ink consumed by the respective jobs. In an example, the number of pages consumed by a job may depend on whether the respective job involves simplex printing or duplex printing. In another example, a quantity of ink consumed by a job may depend on number of colors and a print resolution indicated by the respective job. Accordingly, based on the analysis of the jobs by the services analysis module 108, a level of utilization of the imaging device 102 by each of the client devices 104-1, 104-2, . . . and 104-n is ascertained.

In an example implementation of the present subject matter, as explained previously, the imaging device 102 further comprises the location determination module 106 coupled to the processor 202. The location determination module 106, is operable to determine respective locations of each of the client devices 104-1, 104-2, . . . and 104-n. The location determination module 106 is further operable to identify a location for the imaging device 102 from amongst the locations of the client devices 104-1, 104-2, . . . and 104-n, based on the level of utilization of the imaging device 102 by each of the client devices 104-1, 104-2, . . . and 104-n as determined by services analysis module 108 by analysing the jobs received by the imaging device 102.

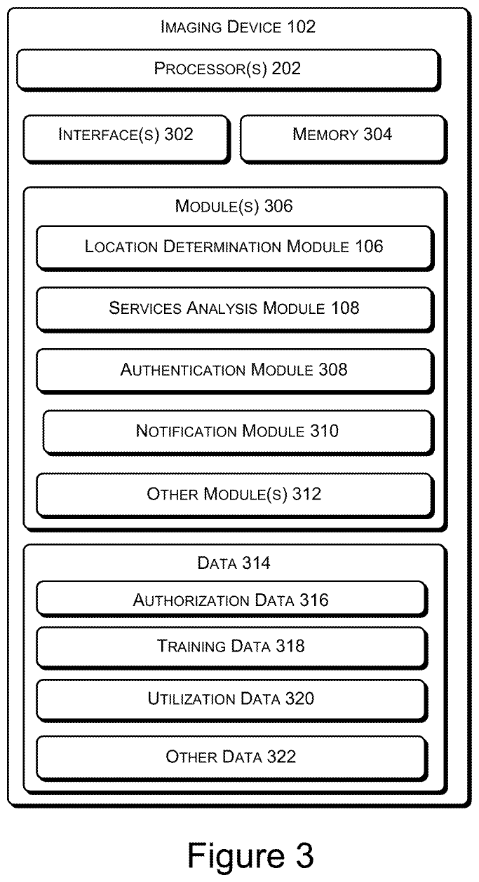

FIG. 3 illustrates the imaging device 102 according to another example implementation of the present subject matter. In an example, the imaging device 102 depicted in FIG. 3 may include plotters, printers, scanners, single function printer (SFP), multi-function printer (MFP), and photocopiers.

As explained previously, the imaging device 102 may receive jobs from the client devices 104-1, 104-2, . . . and 104-n communicatively coupled to the imaging device 102 to use the functionalities of the imaging device 102. The imaging device 102 and the client devices 104-1, 104-2, . . . and 104-n may be housed in the networked environment 100 as depicted in FIG. 1. A job may be a scan job or a print job and comprises instructions to render contents associated with the job on a compatible medium.

As depicted in FIG. 3, in an example implementation, interface(s) 302 may be coupled to a processor 202. The interface(s) 302 may include a variety of software and hardware interfaces that allow interaction of the imaging device 102 with other communication and computing devices, such as network entities, web servers, and external repositories, and peripheral devices. For example, the interface(s) may couple the imaging device 102 with the client devices 104-1, 104-2, . . . and 104-n. The interface(s) 302 may also enable coupling of internal components of the imaging device 102 with each other.

Further, the imaging device 102 comprises a memory 304 coupled to the processor 202. The memory 304 may include any computer-readable medium known in the art including, for example, volatile memory (e.g., RAM), and/or non-volatile memory (e.g., EPROM, flash memory, etc.). The memory 304 may also be an external memory unit, such as a flash drive, a compact disk drive, an external hard disk drive, or the like. The imaging device 102 may comprise module(s) 306 and data 314 coupled to the processor 202. In one example, the module(s) 306 and data 314 may reside in the memory 304.

In an example, the data 314 may comprise an authorization data 316, and utilization data 320 and other data 322. The module(s) 306 may include routines, programs, objects, components, data structures, and the like, which perform particular tasks or implement particular abstract data types. The module(s) 306 further includes modules that supplement applications on the imaging device 102, for example, modules of an operating system. The data 314 serves, amongst other things, as a repository for storing data that may be fetched, processed, received, or generated by one or more of the module(s) 306. The module(s) 306 may include an authentication module 308, a notification module 310 and other module(s) 312, in addition to the location determination module 106 and the services analysis module 108 as described previously. The other module(s) 312 may include programs or coded instructions that supplement applications and functions, for example, programs in the operating system of the imaging device 102.

In an example, the imaging device 102 is operable to determine a location for itself within the networked environment 100. For the purpose, the imaging device 102 may be trained to identify locations of the client devices 104-1, 104-2, . . . and 104-n in the networked environment 100 and to identify a location for itself from amongst the identified locations of the client devices 104-1, 104-2, . . . and 104-n that would result in maximum utilization of the imaging device 102 by the client devices 104-1, 104-2, . . . and 104-n in the networked environment 100.

The imaging device 102 may be trained to identify a location of a client device using the training data 318. To prepare the training data 318 for training the imaging device 102, at least three client devices such as client devices 104-1, 104-2 and 104-3 are initially installed in the networked environment 100.

In operation, to determine the respective locations of each of the at least three client devices 104-1, 104-2, . . . and 104-n, the location determination module 106, may receive an RSSI value from each of the at least three client devices 104-1, 104-2, . . . and 104-n. The RSSI values may be received using a technique of wireless communication, such as Wi-Fi, Bluetooth, near field communication (NFC) or infrared. The distance of each of the client devices 104-1, 104-2, . . . and 104-n may be determined using a technique of wireless communication other than the one used for receiving the RSSI value from each of the client devices 104-1, 104-2, . . . and 104-n and selected from Wi-Fi, Bluetooth, NFC, infrared and the like.

In an alternate implementation, the respective distances of each of the client devices 104-1, 104-2, . . . and 104-n with respect to imaging device 102 may be calculated using the RSSI value received from the corresponding device. For example, if RSSI values from each of the client devices 104-1, 104-2, . . . and 104-n is received using Wi-Fi technology, wherein each client device acts as a Wi-Fi device and the imaging device 102 act as a Wi-Fi access point, the following formula may be used to calculate a distance of a client device from the imaging device 102.

$$distance = {10}^{( \frac{27.55 ( 20 * {log}_{10} ( frequency ) ) + RSSI}{20} )} \qquad Equation ( 1 )$$

### Wherein,

Distance=Displacement between Wi-Fi Station and Wi-Fi Access Point in meters;
Frequency=Wi-Fi signal frequency in MHz;
RSSI=Received Signal Strength Indicator value in dbm.

The location determination module 106 further receives from each of the client devices 104-1, 104-2, . . . and 104-n, respective distances of the client device with respect to the other client devices. Each client device, to determine its distance with respect to the other client devices 104-1, 104-2, . . . and 104-n, may receive RSSI values from the other devices using a technique of wireless communication selected from W-Fi, NFC, Bluetooth, infrared and the like. Using the corresponding RSSI values received from the other client devices, a client device may calculate its distance with respect to other client devices. For example, if Wi-Fi technology may be used for this purpose, each client device may be enabled to act as a Wi-Fi access point. The client device acting as a Wi-Wi access point may receive the RSSI values from the other client devices acting as Wi-Fi devices and may calculate its distance with respect to the other devices using the above-mentioned formula (equation (1)). Alternatively, in another example, for enhanced accuracy, each client device may determine the distance with respect to the other client devices using a wireless communication technique other than the one used for receiving the RSSI value from other client devices.

Having received or determined the distances of each of the client devices 104-1, 104-2, . . . and 104-n from the imaging device 102 and the other client devices, the location determination module 106 may identify the location of each of the client devices 104-1, 104-2, . . . and 104-n in a three dimensional space formed by the imaging device 102 and the client devices 104-1, 104-2, . . . and 104-n. In an example implementation, a multilateration technique may be used for this purpose. For example, the location of a client device, such as client device 104-1 may be determined using the multilateration technique on the distances of the client device 104-1 with respect to the imaging device 102 and at least two of the other client devices, such as client devices 104-2 and 104-3.

The location determination module 106 may further obtain a unique identifier of each of the client devices 104-1, 104-2, . . . and 104-n. For instance, a MAC address of each of the client devices 104-1, 104-2, . . . and 104-n may be obtained from the messages received from the respective client devices 104-1, 104-2, . . . and 104-n. In an example, an administrator of the imaging device 102 may be prompted to assign a user-friendly name to the identified location of the corresponding client device within the networked environment 100. The administrator may assign a user-friendly name to the location of the corresponding device. Accordingly, the location determination module 106 may store, for each of the client devices 104-1, 104-2, . . . and 104-n, the unique identifier of the respective client device along with the identified location, the corresponding RSSI value or the distance of the corresponding device from the imaging device 102 as determined by the imaging device 102. In an example, the user-friendly name assigned to the locations of the client devices 104-1, 104-2, . . . and 104-n along with device identifier of the corresponding devices may be stored in the memory 304 as the training data 318.

Once the imaging device 102 is trained to identify a location of a client device, the location determination module 106 may identify a location of an additional client device, other than the three client devices initially identified, that may be detected within the networked environment 100 using the training data 318. To identify a location of the additional client device detected in the networked environment 100, in an example, the location determination module 106 may receive an RSSI value from the additional client device using a technique of wireless communication such as Wi-Fi, NFC, Bluetooth, infrared and the like. Based on the received RSSI value, the location determination module 106 may calculate the distance of the additional client device from the imaging device 102. In another example, the location determination module 106 may determine the distance of the additional client device with respect to the imaging device 102 using a wireless communication technique other than the one used for receiving the RSSI value from the additional client device.

In an implementation of the present subject matter, the location determination module 106 may identify the location of the additional client device based on the received RSSI value and the distance of the additional client device from the imaging device 102. The training data 318 stored in the memory 304 of the imaging device 102 may be used for this purpose. For example, the location determination module 106 may implement a Machine-Learning algorithm, such as the Random Forest Classifier, that may operate based on the training data 318 to identify the location of the additional client device using the RSSI value and the distance of the additional client device from the imaging device 102.

In another implementation of the present subject matter, the location determination module 106 may identify the location of the additional client device based on the RSSI value received from the additional client device and the locations of two of the client devices from the locations of client devices 104-1, 104-2, . . . and 104-n stored in the training data 318.

Upon identification of the location of the client devices 104-1, 104-2, . . . and 104-n housed in the networked environment 100 by the location determination module 106, to identify a location for the imaging device 102 within the networked environment 100 such that the utilization of the imaging device 102 by the client devices 104-1, 104-2, . . . and 104-n is maximized, the services analysis module 108 is initiated.

The services analysis module 108 may analyse jobs issued by each of the client devices 104-1, 104-2, . . . and 104-n to the imaging device 102 to ascertain a level of utilization of the imaging device 102 by each of the client devices 104-1, 104-2, . . . and 104-n. The level of utilization of the imaging device 102 by a client device may depend on the consumption of consumable supplies by the imaging device 102 in the execution of the jobs issued by the corresponding client device. Examples of the consumable supplies include but are not limited to pages of print media, quantity and number of color of printing ink. The printing ink may include toner, pigments of different colors and various additives.

To ascertain the level of utilization for a client device, the services analysis module 108 determines a number of pages of a print media and a quantity of printing ink to be consumed by the jobs issued by the respective device. The number of pages consumed by a job may be determined based on a determination of whether a simplex printing or duplex printing is to be performed in the execution of the job. Further, a quantity of printing ink to be consumed by a job may depend on number of colors and printing resolution to be used to execute the job. Based on the determination of a number of pages and the quantity of printing ink consumed by each of the jobs issued by each of the client devices 104-1, 104-2, . . . and 104-n, a weight is assigned to each of the jobs based on predefined criteria. For instance, a job, in the execution of which high-resolution printing is to be performed, is expected to consume more quantity of printing ink as compared to a job, in the execution of which, low resolution is to be used, and thus, may be assigned a higher weight. Similarly, a job, in the execution of which, monochrome printing is to be performed is expected to consume more quantity of ink as compared to a job, in the execution of which, a color printing is to be performed and thus may be assigned a higher weight. A job, execution of which consumes more number of pages may be assigned a higher weight as compared to a job that consumes less number of pages in its execution. Similarly, a job that involves printing using several colors may be assigned a higher weight as compared to a job that involves printing using a fewer number of colors.

In an example implementation, the service analysis module 108, for each of the client devices 104-1, 104-2, . . . and 104-n, maintains a mapping of locations of the respective client devices 104-1, 104-2, . . . and 104-n along with a corresponding weight in the memory 304 of the imaging device 102. The weight, for a client device, may be calculated, using the weights assigned to each of the jobs issued by the client device to the imaging device 102 over a period of time. For example, the service analysis module 108 may store data relating to analysis of the jobs from a previous instance of initiation of the location determination module 106 to identify a location for the imaging device 102 to a subsequent instance. Initially, when no job has been issued to the imaging device 102 by a client device located at a location in the networked environment 100, the client device may be assigned a weight, i.e., 0. With each incoming job, the service analysis module 108 may keep on updating the weight of each of the jobs from the respective client devices 104-1, 104-2, . . . and 104-n.

The weight assigned to a client device may be considered as indicative of a level of utilization of the imaging device 102 by the respective client device. A client device that has highest weight from amongst the client devices 104-1, 104-2, . . . and 104-n in the networked environment 100 is considered to be utilizing the imaging device 102 to a maximum extent. The level of utilization is stored as utilization data 320 by the services analysis module 108.

Based on the utilization data 320, the location determination module 106 may identify a location for the imaging device 102 from amongst the locations of the client devices 104-1, 104-2, . . . and 104-n, based on the weight assigned to each of the plurality of jobs received from the respective client devices 104-1, 104-2, . . . and 104-n. In an example, a location of a client device that has a highest level of utilization, from amongst client devices 104-1, 104-2, . . . and 104-n, based on the weight assigned to the jobs generated by the client device may be identified as a location for the imaging device 102.

After identifying the location for the imaging device 102, the notification module 310 may notify the user or administrator of the imaging device 102, to relocate the imaging device 102 to the location for the imaging device 102 identified by the location determination module 106. If the administrator opts to relocate the imaging device 102 to a location as notified by the notification module 310, the location determination module 106 may be notified of or may detect the updated location of the imaging device 102. Accordingly, the location determination module 106 may update the location of the imaging device 102 in the training data 318.

In an example implementation, the process of initiating the imaging device 102 to identify a location for itself within the networked environment 100 may be initiated by an authorized user alone. An authorized user, for example, an administrator of the imaging device 102 may send a request to the imaging device 102 to initiate the location determination module 106 to determine respective locations of each of the client devices 104-1, 104-2, . . . and 104-n within the networked environment 100. For example, the user may generate the request using a graphical user interface of the imaging device 102 or through a client device coupled to the imaging device 102. In an example, the authentication module 308 receives the request and authenticates the user based on the authorization data 316. The authorization data 316 may be captured through a registration process and stored in the memory 304 of the imaging device 102. Based on the authentication of the user, the location determination module 106 may be initiated and the process of identifying a location for the imaging device 102 within the networked environment 100 may be carried out. Authentication of the user initiating the process of identifying the location prevents an unauthorized user, such as rogue user from changing the location of the imaging device 102 within the networked environment 100.

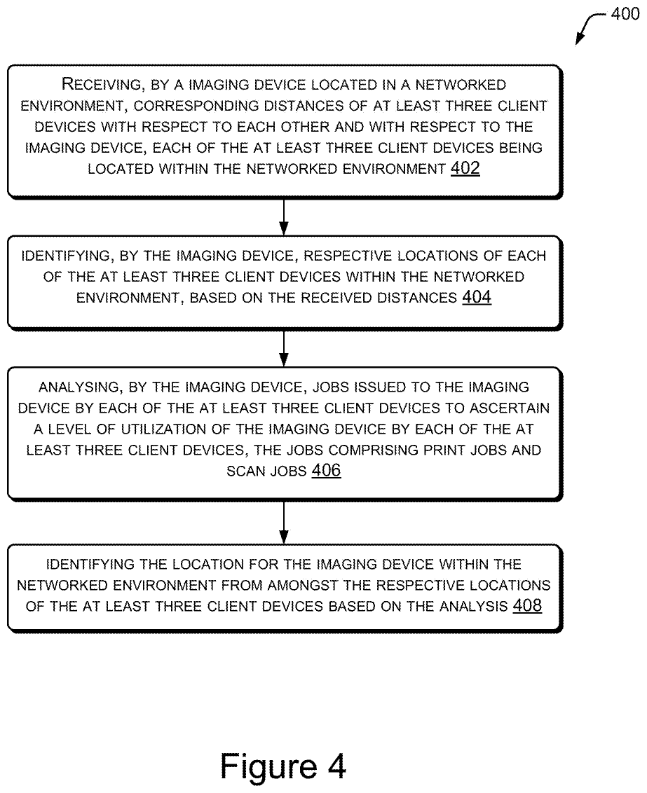

FIG. 4 illustrates a method 400 of identifying a location for an imaging device, according to an example of the present subject matter. Although the method 400 may be implemented in a variety of imaging devices, for the ease of explanation, the present description of the example method 400 is provided in reference to the above-described imaging device 102.

The order in which the method 400 is described is not intended to be construed as a limitation, and any number of the described method blocks may be combined in any order to implement the method 400, or an alternative method.

It may be understood that blocks of the method 400 may be performed, for example, by the above-described imaging device 102, as illustrated in FIGS. 1, 2 and 3. As mentioned previously, the imaging device 102 may be installed in networked environment, such as the networked environment 100 described in reference to FIG. 1. In an example, the networked environment 100 may be understood as an interconnection of the imaging device 102 and the plurality of client devices 104-1, 104-2, . . . and 104-n that communicate with the imaging device 102 to avail the services thereof. The blocks of the method 400 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

Referring to FIG. 4, at block 402, the imaging device 102 receives distances of at least three client devices, such as the client devices 104-1, 104-2, and 104-3 located within the networked environment 100, with respect to each other and the imaging device 102.

In an example, a client device, such as the client device 104-1, to calculate its distances from other client devices 104-2 and 104-3 and the imaging device 102, may receive an RSSI (received signal strength indicator) value from the other client devices 104-2 and 104-3 and the imaging device 102 using a technique of wireless communication, for example, Wi-Fi, Bluetooth, NFC, or infrared. The client device 104-1 may calculate its distance from other client devices 104-2 and 104-3 and the imaging device 102 using the corresponding RSSI values and communicate the calculated distance to the imaging device 102.

In another example, the imaging device 102 may receive the respective distances of the client devices 104-1, 104-2, and 104-3 with respect to each other and the imaging device 102 based on user input. For instance, a user, such as an administrator of the imaging device 102 feed in data indicative of the corresponding distances.

At block 404, the imaging device 102 identifies respective locations of the client devices 104-1, 104-2, and 104-3 within the networked environment, 100 based on the received distances. In an example implementation, having determined the respective locations of the three client devices 104-1, 104-2, and 104-3, the locations of other client devices within the networked environment 100, may be identified using the multilateration technique as explained previously.

Further, as described previously, the client devices 104-1, 104-2, and 104-3 may issue jobs to the imaging device 102 for rendering contents on a compatible medium. The jobs may include but not limited to a print job and a scan job. At block 406, the imaging device 102 analyses the jobs issued to the imaging device 102 by the client devices 104-1, 104-2, and 104-3 to ascertain a level of utilization of the imaging device 102 by the client devices 104-1, 104-2, and 104-3.

In an example, the level of utilization of the imaging device 102 by a client device may be based on a number of jobs received by the imaging device 102 from the given client device. Since the number of jobs generated by a client device may determine the number of times the imaging device 102 is accessed by a user of the client device, greater instances of accessing the imaging device 102 may indicate a higher level of utilization of the imaging device 102.

In another example, the level of utilization of the imaging device 102 by a client device may be based on consumption of consumable supplies by the imaging device 102 in the execution of the jobs generated by the client device over a predetermined period of time. For instance, a number of pages of print media, a number of colors of printing ink, volume of printing ink and so on, consumed for execution of the jobs, may indicate the level of utilization of the imaging device 102 by the client device. The printing ink may include but is not limited to toner, pigments and various additives. The pigment may be of any color. Higher consumption of consumable supplies in execution of the jobs generated by a client device may indicate a higher instance of accessing the imaging device 102 by a user of the client device, for example, to replenish the consumable supplies and may indicate a higher level of utilization of the imaging device 102.

In another example, the level of utilization of the imaging device 102 by a client device may be based on the number of jobs received by the imaging device 102 from the given client device as well as the consumption of consumable supplies by the imaging device 102 in execution of the jobs generated by the client device.

At block 408, based on the analysis the jobs issued to the imaging device 102 by the client devices 104-1, 104-2, and 104-3 to ascertain a level of utilization of the imaging device 102 by the respective devices, the imaging device 102 identifies a location for the imaging device 102 within the networked environment 100, from amongst the respective locations of the client devices 104-1, 104-2, and 104-3. In an example, the level of utilization ascertained for the client devices 104-1, 104-2, and 104-3 after analysing the jobs issued by the respective client devices may be used to identify a client device that is utilizing the imaging device 102 more than any other client devices. The location of the client device that has higher utilization of the imaging device 102 may be identified as the location for the imaging device 102 within the networked environment 100.

In an example implementation, an additional client device may be identified in the networked environment 100 by the imaging device 102. The imaging device 102 may identify a location of the additional client device based on a distance of the additional client device with respect to the imaging device 102 and distances of two client devices, from amongst the three client devices 104-1, 104-2, and 104-3, with respect to the imaging device 102. The imaging device 102 may further analyse the jobs issued to the imaging device 102 by the additional client device to ascertain a level of utilization of the imaging device 102 by the additional client device. The location for the imaging device 102 may be identified from amongst the identified locations of the client devices 104-1, 104-2, . . . and 104-n located in the networked environment 100.

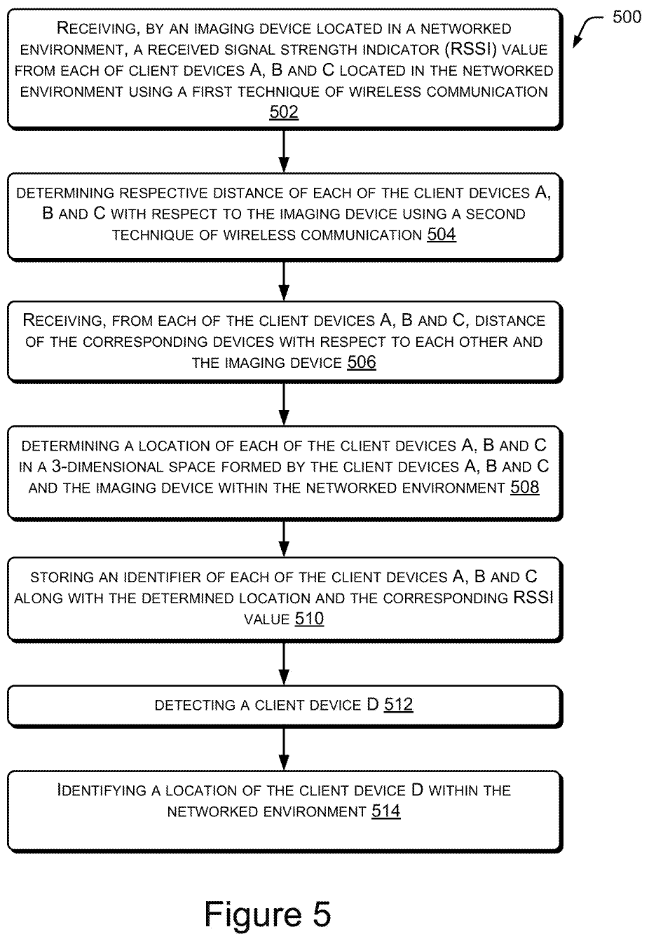

FIG. 5 illustrates a method 500 of training the imaging device 102 installed in the networked environment 100 to identify location of a client device such as the client devices 104-1, 104-2, . . . and 104-n, according to an example of the present subject matter. Although the method 500 may be implemented in a variety of imaging devices, as is the case with method 400, for the ease of explanation, the method 500 is described in reference to the imaging device 102.

The method 500 may be implemented by a processor(s) or imaging device(s) through any suitable hardware, non-transitory machine-readable instructions, or combination thereof. It may be understood that blocks of the method 500 may be performed by programmed imaging devices such as the imaging device 102. The blocks of the method 500 may be executed based on instructions stored in a non-transitory computer readable medium, as will be readily understood. The non-transitory computer readable medium may include, for example, digital memories, magnetic storage media, such as magnetic disks and magnetic tapes, hard drives, or optically readable digital data storage media.

To train the imaging device 102 to identify a location of a client device which utilizes the imaging device 102, at least three client devices such as the client devices 104-1, 104-2 and 104-3 (referred to as client devices A, B, and C hereinafter) may be installed in the networked environment 100. The client devices 104-1, 104-2, . . . and 104-n are communicatively coupled to the imaging device 102.

Referring to FIG. 5, at block 502, to initiate the training, the imaging device 102 receives an RSSI value, from the respective client devices A, B and C located in the networked environment 100 using a first technique of wireless communication. The first technique of wireless communication may be selected from Wi-Fi, Bluetooth, NFC, infrared and the like. In an example, if Wi-Fi is used as the first technique of wireless communication, the imaging device 102 acts as a Wi-Fi access point and receives an RSSI value in a message received from the client devices A, B and C that may be working as Wi-Fi devices.

At block 504, the imaging device 102 determines the respective distance of each of the client devices A, B and C with respect to the imaging device 102 using a second technique of wireless communication. The second technique of wireless communication may be any technique of wireless communication other than the first technique used to determine the RSSI value at block 502 and may be selected from Wi-Fi, Bluetooth, NFC, infrared and the like.

While, in the example implementation depicted in method 500, at block 504, the second technique of wireless communication different from the first technique may be used to achieve higher accuracy in computation of the respective distances, it will be understood based on the foregoing description that the respective distances of the client devices A, B and C with respect to the imaging device 102 may also be computed using the RSSI value determined at block 502 using the first technique. The distance of the imaging device 102 from each of the client devices A, B, and C may be calculated using the RSSI value received from the corresponding device. In an example, the below-mentioned formula may be used to calculate the distance between the imaging device as a Wi-Fi Access Point and each of the client devices A, B and C as a Wi-Fi device.

$$distance = {10}^{( \frac{27.55 ( 20 * {log}_{10} ( frequency ) ) + RSSI}{20} )} \qquad Equation ( 1 )$$

### Wherein,

Distance=Displacement between Wi-Fi Station and Wi-Fi Access Point in meters;
Frequency=Wi-Fi signal frequency in MHz;
RSSI=Received Signal Strength Indicator value in dbm.

At block 506, the imaging device 102 receives, from each of the client devices A, B and C, a distance of the corresponding devices with respect to each other. In an example, the distances of a client device with respect to other client devices may be determined using a technique of wireless communication such as Wi-Fi, Bluetooth, NFC, infrared and the like. For example, the distances of a client device with respect to other client devices may be determined using an RSSI value received from the other client devices through a technique of wireless communication, such as Wi-Fi, Bluetooth, NFC and infrared. If Wi-Fi is used to determine distances of each of the client devices with respect to each other, each of the client devices A, B and C act as a Wi-Fi access point one by one. The client device acting as a Wi-Fi access point receives an RSSI value from each of the other client devices which are acting as Wi-Fi devices. Each of the client devices A, B, and C sends distances of the corresponding devices with respect to each other to the imaging device 102.

At block 508, the imaging device 102 determines a location of each of the client devices A, B and C in a 3-dimensional space formed by the client devices A, B and C and the imaging device 102 within the networked environment 100. The distances received from each of the client devices A, B, and C may be used to determine the location of each of the client devices A, B and C. In an example, a multilateration technique may be used to identify the locations of each of the client devices A, B and C. For example, the location of the client device A, i.e., LOC(A) may be determined by using multilateration technique on the distances of client device A from the imaging device and the client devices B and C as determined by the imaging device 102 and the client devices B and C, respectively.

In an example, a user-friendly name may be assigned to each of the identified locations of the client devices. For instance, the imaging device may display a device identifier such as a MAC address of a client device, such as client device A and may prompt a user of the corresponding client device or an administrator of the imaging device 102 to indicate a user-friendly name of a section of the networked environment 100 associated with the client device A. For example, the user of the client device A may then indicate the location of the client device A that is determined by the multilateration technique as ‘living room’.

At block 510, the imaging device 102 stores for each of the client devices, the client device identifier of the client device along with the identified location, the corresponding RSSI value or the distance of the corresponding device from the imaging device as determined by the imaging device 102. In an example, the user-friendly name assigned to the locations of each of the client devices A, B, and C may also be stored along with a device identifier of the corresponding devices. This stored data may also be referred to as a training model or training data 318.

At block 512, the imaging device 102 detects a client device D in the networked environment 100. An additional client device, such as the client device D, if detected in the networked environment 100, may be distinguished from the client devices A, B and C located in the networked environment 100 using an device identifier of the client device D which may be obtained by the imaging device 102 in a message received from the client device D, and the stored device identifiers of each of the client devices A, B and C. At block 514, the imaging device 102 then identifies a location of the client device D within the networked environment 100.

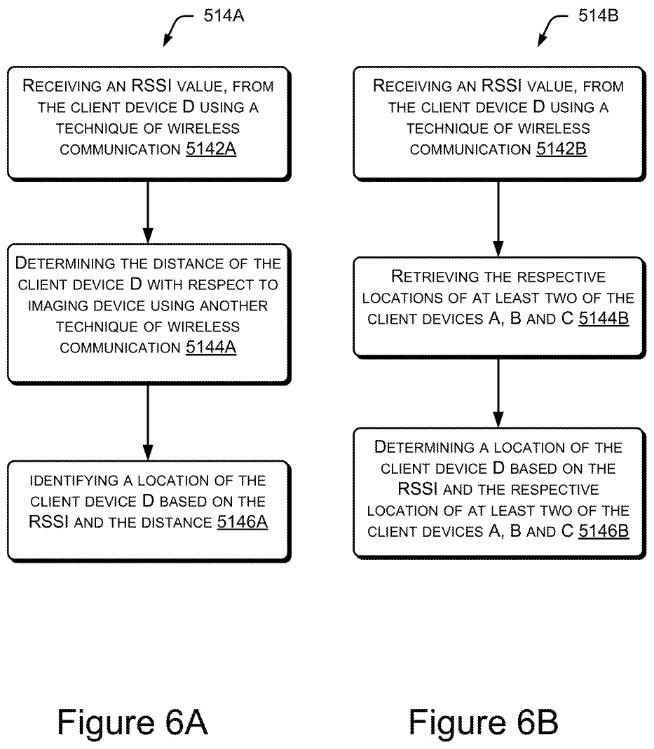

FIGS. 6A and 6B illustrate two alternate methods 514A and 514B, respectively of identifying the location of the client device D within the networked environment 100, according to an example of the present subject matter.

Referring to FIG. 6A, in an example, at block 5142A, the imaging device 102 receives an RSSI value from the client device D using a technique of wireless communication such as Wi-Fi, Bluetooth, infrared, NFC and the like. At block 5144A, the imaging device 102 determines the distance of the client device D with respect to itself using another technique of the wireless communication.

At block 5146A, the imaging device 102 identifies the location of the client device D based on the received RSSI and the distance of the client device D. In an example, the training data 318 stored in step 510 may be used to identify a location of the client device D based on the received RSSI and the distance of the client device D. In an example, to identify the location of the client device D, in real-time, i.e., after the imaging device 102 has been trained in accordance with method 500, a Machine-Learning algorithm, such as, the ‘Random Forest Classifier algorithm’ may be used by the imaging device 102. After the training phase, this algorithm takes the RSSI value of the client device D and the distance of the client device D from the imaging device 102 as input parameters and gives the location of the client device D as output.

Referring to FIG. 6B, at block 5142B, similar to the steps performed at block 5142A of the method 514A, the imaging device 102 receives an RSSI value from the client device D using a technique of wireless communication, such as Wi-Fi, Bluetooth, NFC or infrared. At block 5144B, the imaging device 102 may retrieve the respective locations of at least two client devices, such as the locations of two of the client devices A, B or C, from the locations of client devices identified and stored during the training phase. The imaging device 102 may also retrieve the distances of at least two of the client devices A, B and C with respect to the imaging device 102. At block 5146B, the location of the client device D may be determined based on the RSSI value received at block 5122B and the respective locations of at least two of the client devices A, B or C.

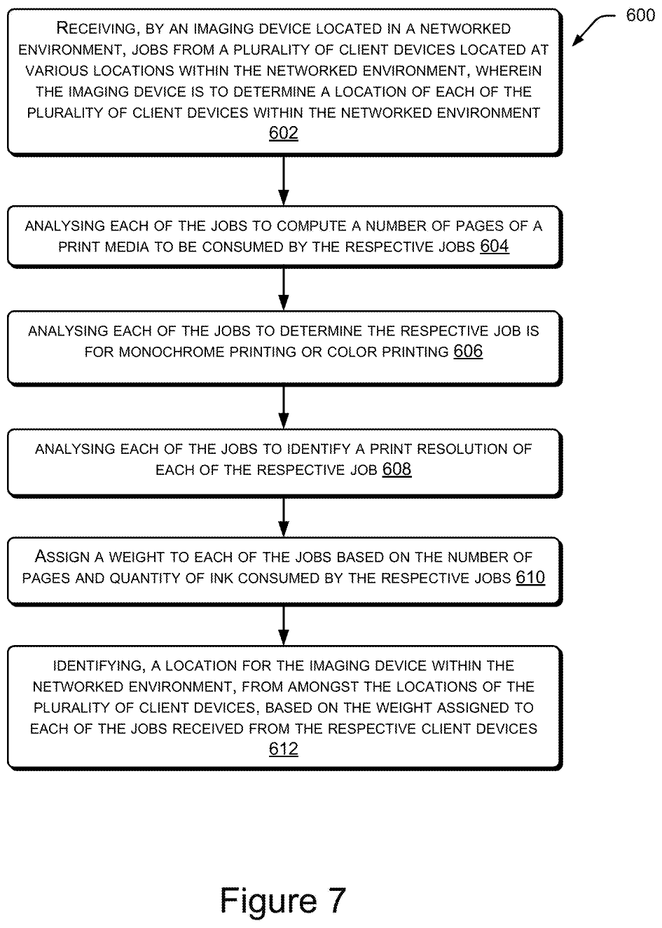

FIG. 7 illustrates a method 600 for identifying a location for an imaging device 102, such as the above-described imaging device 102 from amongst the respective locations of a plurality of client devices, such as the client devices 104-1, 104-2, . . . and 104-n, according to an example of the present subject matter. Although the method 600 may be implemented in a variety of imaging devices, as is the case with method 500, for the ease of explanation, the method 600 is described in reference to the imaging device 102. As mentioned previously, the imaging device 102 and the client devices 104-1, 104-2, . . . and 104-n may be communicatively coupled, so that the client devices 104-1, 104-2, . . . and 104-n may use the functionalities of the imaging device 102. The imaging device 102 and the client devices 104-1, 104-2, . . . and 104-n may be located in networked environment, such as the networked environment 100, wherein the imaging device 102 may identify the respective locations of the client devices 104-1, 104-2, . . . and 104-n within the networked environment 100, for example, based on the previously described methods 400, 514A, and 514B implemented by the imaging device 102.

In an example, the method 600 may be implemented by a processor(s) or imaging device(s) through any suitable hardware, non-transitory machine-readable instructions, or combination thereof. It may be understood that blocks of the method 600 may be performed by programmed imaging devices. The blocks of the method 600 may be executed based on instructions stored in a non-transitory computer readable medium, as will be readily understood. The non-transitory computer readable medium may include, for example, digital memories, magnetic storage media, such as magnetic disks and magnetic tapes, hard drives, or optically readable digital data storage media.

At block 602, the imaging device 102 receives jobs from the client devices 104-1, 104-2, . . . and 104-n located at various locations within the networked environment 100. As apparent from the foregoing description, the imaging device 102 may be aware of the respective location of the client devices 104-1, 104-2, . . . and 104-n within the networked environment 100 or may identify the same upon receipt of a job from the respective client devices 104-1, 104-2, . . . and 104-n. The job may be a print job or a scan job.

At block 604, the imaging device 102 may analyse the jobs received from the respective client devices 104-1, 104-2, . . . and 104-n to compute a number of pages of print media to be consumed by the jobs generated by the respective client devices 104-1, 104-2, . . . and 104-n. The imaging device 102, at block 606, may further analyse the jobs to determine if the respective jobs involve monochrome printing or color printing. Further, at block 608, the imaging device 102 analyses the jobs to identify a print resolution of the respective jobs. Having analysed each of the jobs generated by the client devices 104-1, 104-2, . . . and 104-n, the imaging device 102 may determine a quantity of print media and ink consumed by the respective client devices 104-1, 104-2, . . . and 104-n. The ink may include but not limited to toner, pigments and various additives. The pigment may be of any color.

At block 610, the imaging device 102 assigns a weight to each of the jobs based on the number of pages and quantity of ink consumed by the respective jobs. A job that involves color printing is expected to consume more quantity of ink as compared to a job that involves monochrome printing and may be assigned more weight than the job that involves monochrome printing, in an example. Similarly, in an example, and a job that involves a high-resolution printing is expected to consume more quantity of ink as compared to a job that involves low resolution of printing and thus, may be assigned a higher weight. Further, a number of pages consumed by each of the jobs depend on a determination of whether the job involves simplex printing or duplex printing and jobs consuming a higher number of pages may be assigned correspondingly higher weights.

In an example implementation, assigning the weights to the jobs generated by the client devices 104-1, 104-2, . . . and 104-n enables determination of the level of utilization of the imaging device 102 by the client devices 104-1, 104-2, . . . and 104-n in accordance with a criterion that may be predetermined. For instance, if the level of utilization of the imaging device 102 is to be determined in accordance with the criterion of number of jobs generated by the respective client devices 104-1, 104-2, . . . and 104-n, the jobs may be assigned same weight irrespective of the number of pages of print media consumed and irrespective of whether they involve monochrome or color printing or simplex or duplex printing. In some examples, where the level of utilization of the imaging device 102 is to be determined in accordance with a volume of ink consumed, independent of the colors of the ink, the weight may be assigned to the jobs accordingly.

At block 612, a location for the imaging device 102 within the networked environment 100 is identified, from amongst the locations of the of client devices 104-1, 104-2, . . . and 104-n, based on the weight assigned to each of the jobs received from the respective client devices 104-1, 104-2, . . . and 104-n that may be received over a period of time. A client device, the jobs issued by which have been assigned the highest weight from amongst the jobs issued by other client devices 104-1, 104-2, . . . and 104-n, is considered to be utilizing the imaging device 102 in the highest proportion. Accordingly, the location of such a client device may be identified as the location of the imaging device 102.

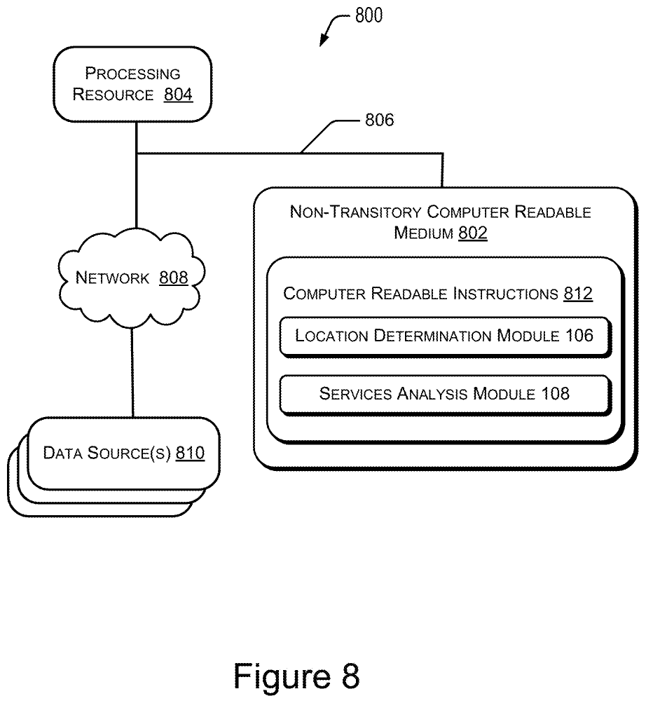

FIG. 8 illustrates a computing environment 800 implementing a non-transitory computer-readable medium 802 for identifying a location for an imaging device, such as imaging device 102 within the networked environment 100, according to an example of the present subject matter.

In an example, the computing environment 800 may comprise the imaging device 102. The computing environment 800 includes a processing resource 804 communicatively coupled to the non-transitory computer-readable medium 802 through a communication link 806. In an example, the processing resource 804 may be a processor of the imaging device 102 that fetches and executes computer-readable instructions from the non-transitory computer-readable medium 802.

The non-transitory computer-readable medium 802 may be, for example, an internal memory device or an external memory device. In an example, the communication link 806 may be a direct communication link, such as any memory read/write interface. In another example, the communication link 806 may be an indirect communication link, such as a network interface. In such a case, the processing resource 804 may access the non-transitory computer-readable medium 802 through a network 808. The network 808 may be a single network or a combination of multiple networks and may use a variety of different communication protocols.

The processing resource 804 and the non-transitory computer-readable medium 802 may also be communicatively coupled to data sources 810. The data source(s) 810 may be used to store details, such as respective device identifiers and locations of the client devices located within the networked environment 100, in an example. In an example, the non-transitory computer-readable medium 802 comprises executable instructions 812 for identifying a location for the imaging device 102 within the networked environment 100, so as to enhance the utilization of the imaging device 102. For example, the non-transitory computer-readable medium 802 may comprise instructions executable to implement the previously described location determination module 106 and services analysis module 108.

In an example, the instructions 812 may cause the processing resource 804 to identify respective locations of at least three client devices located within the networked environment 100. The instructions 812 may cause the processing resource 804 to identify a location of an additional client device, if detected within the networked environment, based at least in part on a distance of the additional client device with respect to the imaging device 102 and distances of two client devices, from amongst the at least three client devices, with respect to the imaging device 102. As apparent from the previous description, identification of the respective locations of client devise located within the networked environment 100 trains the imaging device 102 to identify the potential location for the imaging device 102 within the networked environment 100.

Further, the instructions 812 may also cause the processing resource 804 to analyze jobs issued by the at least three client devices and the additional client device to ascertain a level of utilization of the imaging device 102 by each of the at least three client devices and the additional client device. Also, as apparent based on the previous description, the level of utilization of the imaging device 102 may be based on a quantity of print media and printing ink utilized in the execution of a job, in an example. Upon determination of the level of utilization of the imaging device 102 by the client devices, the instructions 812 may also cause the processing resource 804 to identify a location for the imaging device 102 within the networked environment 100, from amongst the locations of the at least three client devices and the additional client device based on the ascertained level of utilization of the imaging device 102. To identify respective locations of the at least three client devices, the instructions 812 may cause the processing resource 804 to receive, from the at least three client devices, corresponding distances of the at least three client devices with respect to each other and the imaging device 102.

Accordingly, the imaging device 102 may be housed at the location identified based on the level of utilization of the client devices within the networked environment 100 to enhance the ease of accessibility of the imaging device 102 to the client devices that have higher utilization of the imaging device as compared to the other client devices.

Thus, the methods and devices of the present subject matter provide techniques for identifying a location for an imaging device within networked environment, so as to enhance the utilization of the imaging device by various client devices within the networked environment. Although implementations have been described in a language specific to structural features and/or methods, it is to be understood that the appended claims are not necessarily limited to the specific features or methods described. Rather, the specific features and methods are disclosed as example for identifying a location for an imaging device.

1. A method of identifying a location of an imaging device within a networked environment, the method comprising:
receiving, by the imaging device, corresponding distances of at least three client devices with respect to each other and with respect to the imaging device, each of the at least three client devices being located within the networked environment;
identifying, by the imaging device, respective locations of each of the at least three client devices within the networked environment, based on the received distances;
analysing, by the imaging device, jobs issued to the imaging device by each of the at least three client devices to ascertain a level of utilization of the imaging device by each of the at least three client devices, the jobs comprising print jobs or scan jobs; and
identifying the location for the imaging device within the networked environment from amongst the respective locations of the at least three client devices based on the analysis.

2. The method as claimed in claim 1 further comprising:
detecting, by the imaging device, an additional client device within the networked environment,
identifying a location of the additional client device within the networked environment; and
analysing, by the imaging device, jobs issued to the imaging device by the additional client device to ascertain a level of utilization of the imaging device by the additional client device,
wherein the location for the imaging device is identified from amongst the locations of the at least three client devices and the additional client device.

3. The method as claimed in claim 2, wherein identifying the location of the additional client device comprises determining a distance of the additional client device with respect to the imaging device and distances of two of the at least three client devices with respect to the imaging device.

4. The method as claimed in claim 2, wherein identifying the location of the additional client device comprises:
determining, an Received Signal Strength Indicator (RSSI) of a signal received from the additional client device;
determining, the location of the additional client device using a machine learning algorithm based on the of RSSI of the signal received from the additional client device and the distance of the additional client device with respect to the imaging device

5. The method as claimed in claim 1, wherein analysing a job to ascertain the level of utilization of the imaging device comprises determining at, least one of: a number of pages of a print media to be consumed by the job, a number of colors of printing ink to be consumed by the print job, and a volume of printing ink to be consumed by the job.

6. An imaging device comprising:
a processor;
a services analysis module coupled to the processor to:
analyse each of a plurality of jobs to compute a number of pages of a print media to be consumed by the respective jobs and a quantity of printing ink to be consumed by the respective job, wherein the plurality of jobs is received by the imaging device from client devices communicatively coupled to the imaging device; and
assign a weight to each of the plurality of jobs based on the number of pages and quantity of ink consumed by the respective jobs; and a location determination module coupled to the processor to:
determine respective locations of each of the client devices;
identify a location for the imaging device from amongst the locations of the client devices, based on the weight assigned to each of the plurality of jobs received from the respective client devices.

7. The imaging device as claimed in claim 6, wherein to determine the respective locations of each of the client devices, the location determination module is to:
receive, from at least three client devices, from amongst the client devices, corresponding distances of the three client devices with respect to each other and the imaging device;
identify respective locations of each of the at least three client devices based on the received distances;
determine, for an additional client device, from amongst the client devices, other than the at least three client devices, the additional client device with respect to the imaging device; and
identify a location of the additional client device based on the distance of the additional client device with respect to the imaging device.

8. The imaging device as claimed in claim 7, wherein the location determination module is to compute a distance of the additional client device with respect to the printer based on Received Signal Strength Indicator (RSSI) of a signal received from the additional client device.

9. The imaging device as claimed in claim 8, wherein the RSSI is measured using a first technique of wireless communication.

10. The imaging device as claimed in claim 8, wherein the location determination module is to compute the distance of the additional client device with respect to the imaging device based on a second technique of wireless communication.

11. The imaging device as claimed in claim 7, wherein the location determination module is to compute a distance of the additional client device with respect to the imaging device based on distances of two of the at least three client devices with respect to the imaging device.

12. The imaging device as claimed in claim 6 further comprising an authentication module coupled to the processor to:
receive, from a user, a request to initiate the location determination module to determine respective locations of each of the client devices; and
initiate the location determination module based on the authentication of the user.

13. The imaging device as claimed in claim 6 further comprising a notification module coupled to the processor to:
notify a user to relocate the imaging device to the location for the imaging device identified by the location determination module.

14. A non-transitory computer-readable medium comprising computer-readable instructions executable by a processing resource to:
identify, by an imaging device, respective locations of at least three client devices located within a networked environment;
identify a location of an additional client device, if detected within the networked environment, based at least in part on a distance of the additional client device with respect to the imaging device and distances of two client devices, from amongst the at least three client devices, with respect to the imaging device;
analyze print jobs issued by the at least three client devices and the additional client device to ascertain a level of utilization of the imaging device by each of the at least three client devices and the additional client device, the level of utilization being based on a quantity of print media and printing ink utilized in execution of a job;
identify, a location for the imaging device within the networked environment, from amongst the locations of the at least three client devices and the additional client device based on the ascertained level of utilization.

15. The non-transitory computer-readable medium as claimed in claim 14, wherein to identify respective locations of the at least three client devices, the computer-readable instructions are executable by the processing resource to:
receive, from the at least three client devices, corresponding distances of the three client devices with respect to each other and the imaging device.
